(19) United States
(12) Patent Application Publication
(10) Pub. No.: US 2007/0205855 A1
(43) Pub. Date: Sep. 6, 2007

(54) Electronic substrate, semiconductor device, and electronic device

(75) Inventor: Nobuaki Hashimoto, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/708,170

(22) Filed: Feb. 19, 2007

(30) Foreign Application Priority Data
Mar. 3, 2006 (JP) 2006-057673

(51) Int. Cl. H01F 5/00

(52) U.S. Cl. 336/200

(57) ABSTRACT

An electronic substrate includes: a base substrate having an active face and a rear face; inductor elements formed on or above the active face, and formed on or above the rear face; and a conductive member electrically connected to the inductor element formed on or above the rear face, penetrating through the base substrate from the active face to the rear face.

### CROSS-REFERENCE TO RELATED APPLICATION

This application claims priority from Japanese Patent Application No. 2006-057673, filed Mar. 3, 2006, the contents of which are incorporated herein by reference.

### BACKGROUND

1. Technical Field

The present invention relates to electronic substrate, semiconductor device, and electronic device.

2. Related Art

Electronic substrates (semiconductor chips) with integrated circuits are provided in electronic devices such as mobile telephones, notebook personal computers, and personal data assistants (PDA).

Generally, a connection terminal is formed in the electronic substrate, which is packaged on other electronic substrate or motherboard through this connection terminal.

This allows signals such as power transmission signals and communication signals to be exchanged between the electronic substrate and other electronic substrate or motherboard.

However, when a connection terminal is formed on the electronic substrate, there are problems in that the structure becomes complex, or the packaging operation of the connection terminal on other electronic substrate or motherboard becomes complex and troublesome.

In recent years, technology for sending/receiving signals has been developed as disclosed in Japanese Unexamined Patent Application, First Publication No. 2002-164468, or Japanese Unexamined Patent Application, First Publication No. 2003-347410. In these technologies, inductor elements have been formed on the active face of electronic substrates, and electromagnetic waves have been sent/received using these inductor elements as antenna.

In this case, by positioning the active faces of a pair of electronic substrates to face each other, and by disposing the inductor elements of each to face each other, communications can be carried out between the pair of electronic substrates.

However, when three or more electronic substrates are disposed by stacking, there is the problem in that reduction in transmission efficiency occurs when electromagnetic waves are sent/received through the base substrate having electromagnetic shielding properties.

### SUMMARY

An advantage of some aspects of the invention is to provide an electronic substrate and a semiconductor device, in which it is possible to prevent reduction in the transmission efficiency and resolve the problems mentioned above, an electronic device in which is possible to be small power consumption.

A first aspect of the invention provides an electronic substrate including: a base substrate having an active face and a rear face; inductor elements formed on or above the active face, and formed on or above the rear face; and a conductive member electrically connected to the inductor element formed on or above the rear face, penetrating through the base substrate from the active face to the rear face.

According to this configuration, even if the electronic substrates are laminated, the inductor elements of the adjacent electronic substrates can be arranged to face each other.

As a result, there is no need to send/receive electromagnetic wave through a base substrate having electromagnetic shielding properties, and transmission efficiency can be enhanced.

It is preferable that the electronic substrate of the first aspect of the invention further include a connection terminal formed on the base substrate, used for external power transmission.

According to this configuration, power transmission can be performed accurately by this connection terminal.

It is preferable that the electronic substrate of the first aspect of the invention further include a plurality of the inductor elements formed on or above the active face, or on or above the rear face.

According to this configuration, since transmission and communications can be performed using the inductor elements formed on the electronic substrate, the connection terminal on the electronic substrate can be eliminated, and hence, the construction of the electronic substrate can be simplified.

As a result, the packaging operation of electronic substrate can be simplified, moreover, degradation in reliability accompanying the packaging operation can be prevented.

It is preferable that the electronic substrate of the first aspect of the invention further include: a first inductor element; and a second inductor element having an inductance value or an applicable frequency that is different from that of the first inductor element.

Here, the “applicable frequency” is an indication of the characteristic of the inductor as an antenna when the inductor is made to work as an antenna, and is a frequency that can be used for an antenna.

According to this configuration, the functions of each inductor element can be shared. Thereby it is possible to optimally design each inductor element.

As a result, the miniaturization and transmission efficiency of each inductor element can be enhanced.

It is preferable that, in the electronic substrate of the first aspect of the invention, the first inductor element be used for external power transmission, and the second inductor element be used for external communications.

According to this configuration, the inductor element can send/receive all external signals. Thus, connection terminal of the electronic substrate can be eliminated.

It is preferable that, in the electronic substrate of the first aspect of the invention, the first inductor element and the second inductor element be used for external communications.

According to this configuration, the communication speed can be further enhanced.

It is preferable that the electronic substrate of the first aspect of the invention further include a dielectric layer formed between at least some of the inductor elements and the base substrate, made of material having a dielectric dissipation factor smaller than that of the base substrate.

According to this configuration, the absorption of the electromagnetic wave sent by the inductor element as eddy current loss in the base substrate can be prevented. As a result, the performance of the element as an antenna can be enhanced.

A second aspect of the invention provides a semiconductor device including: a plurality of electronic substrates, each of which includes: a base substrate having an active face and a rear face; inductor elements formed on or above the active face and formed on or above the rear face; a conductive member electrically connected to the inductor elements formed on the rear face, penetrating through the base substrate from the active face to the rear face. In this configuration, the electronic substrates are disposed so as to be laminated, and the inductor element functions as an antenna sending or receiving electromagnetic waves so as to send or receive signals between the electronic substrates.

In the above described electronic substrate, inductor elements are formed on or above the active face and formed on or above the rear face of the base substrate. Therefore, even if the electronic substrates are disposed by stacking, the inductor elements of the adjacent electronic substrates can be made to face each other.

As a result, the transmission efficiency can be enhanced.

It is preferable that, in the semiconductor device of the second aspect of the invention, the inductor elements formed on a pair of the electronic substrates, sending or receiving signals, be disposed to face each other.

With such a configuration, the transmission efficiency can be further enhanced. Moreover, interference can be prevented.

A third aspect of the invention provides an electronic device including: the electronic substrate mentioned above.

According to this configuration, electronic device includes the electronic substrate in which the transmission efficiency is enhanced. Therefore, electronic device with small power consumption can be offered.

### BRIEF DESCRIPTION OF THE DRAWINGS

FIGS. 1A to 1C are explanatory views of the electronic substrate related to the first embodiment. FIG. 1A shows a plan view, FIG. 1C shows a bottom view, and FIG. 1B shows a cross-sectional view taken along the line A-A in FIG. 1A (cross-sectional view taken along the line A′-A′ in FIG. 1C).

FIGS. 2A and 2B are explanatory views of the inductor element. FIG. 2A shows a plan view, while FIG. 2B shows a cross-sectional view taken along the line B-B in FIG. 2A.

FIGS. 3A and 3B are explanatory views of the examples of modification of the inductor element. FIG. 3A shows a plan view, while FIG. 3B shows a cross-sectional view taken along the line C-C in FIG. 3A.

FIG. 4 is an explanatory view of a conductive member, and is an enlarged view of part P in FIG. 1B.

FIG. 5 is an explanatory view of a semiconductor device related to the first embodiment, and is a cross-sectional view taken along the line A-A in FIG. 1A.

FIGS. 6A and 6B are explanatory views of the electronic substrate related to the second embodiment. FIG. 6A shows a plan view, while FIG. 6B shows a cross-sectional view taken along the line F-F in FIG. 6A.

FIGS. 7A to 7C are process diagrams of the manufacturing method for electronic substrate related to the second embodiment, they are cross-sectional views taken along the line F-F in FIG. 6A.

FIGS. 8A to 8B are process diagrams of the manufacturing method for electronic substrate related to the second embodiment, they are cross-sectional views taken along the line F-F in FIG. 6A.

FIG. 9 is an explanatory view of the semiconductor device related to the second embodiment, and is a cross-sectional view taken along the line F-F in FIG. 6A.

FIG. 10 is a perspective view of a mobile telephone.

### DESCRIPTION OF EXEMPLARY EMBODIMENTS

The embodiments of this invention are described here referring to the views.

The scale of each member shown in each view used in the explanations below has been changed appropriately to a suitable size to enable each member to be easily recognized.

### First Embodiment

The electronic substrate related to the first embodiment is described here at first.

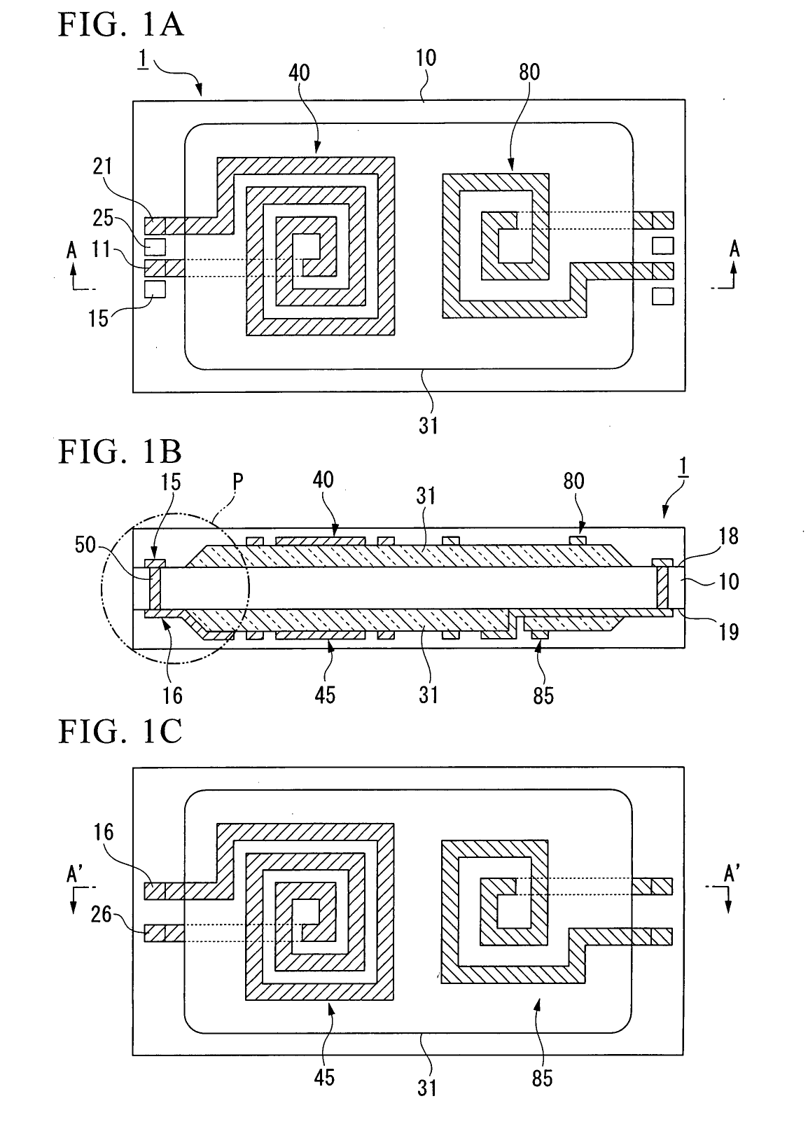

FIGS. 1A to 1C are explanatory views of the electronic substrate related to the first embodiment. FIG. 1A shows a plan view, FIG. 1C shows a bottom view, and FIG. 1B shows a cross-sectional view taken along the line A-A in FIG. 1A (cross-sectional view taken along the line A′-A′ in FIG. 1C).

As shown in FIG. 1B, electronic substrate 1 related to the first embodiment includes a base substrate 10 made of a material such as silicon, glass, quartz, or crystal, and a plurality of inductor elements 40, 45, 80, and 85.

The inductor elements 40, 80 are each formed with different inductance value or different applicable frequency on the active face 18 of the base substrate 10.

The inductor elements 45 and 85 are each formed with different inductance value or different applicable frequency on the rear face 19 of the base substrate 10.

Electronic circuit (not shown in the figures) is formed on the active face 18 of the base substrate 10.

This electronic circuit includes at least a wiring pattern formed thereon, semiconductor elements such as a plurality of thin film transistors (TFT), or a plurality of passive components (parts), and wiring that connects these parts.

A dielectric layers 31 described later, are formed at the center of the active face 18 and at the center of the rear face 19 of the base substrate 10.

These dielectric layers 31 may be formed over the entire surface of the active face 18 and the rear face 19.

If the electronic substrate 1 is an insulator, the dielectric layer 31 is not always necessary. For instance, the dielectric layer 31 may be formed to proactively obtain optimum inductor characteristics by improving the Q value or by adjusting the self-resonant frequency.

Electrodes 21, 25, 11, and 15 are arrayed and formed at the peripheral portion of the active face 18 of the base substrate 10 for electrical connectivity of the electronic circuit to external parts.

The inductor element 40 is formed that extends over the surface of the dielectric layer 31 from the electrodes 11 and 21.

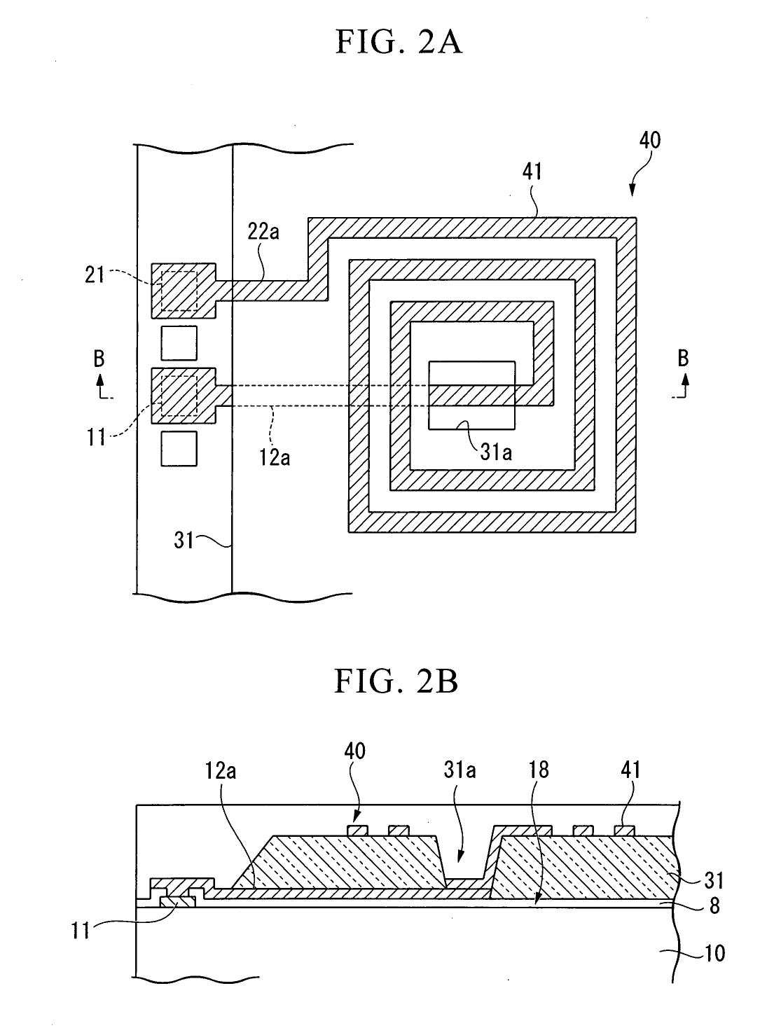

FIGS. 2A and 2B are explanatory views of the inductor element, FIG. 2A shows a plan view, while FIG. 2B shows the cross-sectional view taken along the line B-B in FIG. 2A.

As shown in FIG. 2B, a passivation film 8 made of an electrically-insulated material such as SiN, is formed on the active face 18 of base substrate 10 to protect the electronic circuit.

Electrode 11 is formed at the peripheral portion of the active face 18 of the base substrate 10 for electrical connectivity of the electronic circuit to external parts.

An opening of the passivation film 8 is formed on the surface of this electrode 11.

A connecting wire 12a is formed that extends over the surface of the passivation film 8 from this opening.

This connecting wire 12a may be a single layer or multi-layer wire made of a single conductive material or compound conductive material that may include copper (Cu), gold (Au), silver (Ag), titanium (Ti), tungsten (W), titanium tungsten (TiW), titanium nitrogen (TiN), nickel (Ni), nickel vanadium (NiV), chrome (Cr), aluminum (Al), or palladium (Pd).

In the case in which the connecting wire 12a is made by the electro-plating method, the connecting wire 12a is generally formed on the surface of the under layer, but the under layer is not shown in FIG. 2B.

The dielectric layer 31 is formed to cover this connecting wire 12a.

A through hole 31a is formed in this dielectric layer 31 to expose the end of the connecting wire 12a.

A winding wire 41 of the inductor element 40 is formed on the surface of this dielectric layer 31.

The material forming the winding wire 41 is the same as the one forming the connecting wire 12a. However, a material with the required resistance range or with characteristics such as permissible current value may be appropriately selected as the material of the winding wire 41.

As shown in FIG. 2A, the winding wire 41 is formed in a substantially rectangular spiral shape, but it may also be formed in a substantially circular shape or a substantially polygonal shape.

As shown in FIG. 2B, the winding wire 41 is formed in the same plane when seen from the side view.

That is, flat inductor element (spiral inductor element) is used as the inductor element 40 in this embodiment.

As shown in FIG. 2A, the outer end of the winding wire 41 is connected to the electrode 21 via the connecting wire 22a.

The inner end of the winding wire 41 is connected to the other end of the connecting wire 12a after penetrating through the through hole 31a.

The other end of this connecting wire 12a is connected to the electrode 11 after it is drawn outside the winding wire 41.

Short-circuiting between the connecting wire 12a and the winding wire 41 is prevented by the dielectric layer 31 when the connecting wire 12a is drawn outside.

The inductor element 40 works as an antenna and outputs electromagnetic waves of the applicable frequency when current flows from the electrodes 11 and 21 to the inductor element 40.

The silicon that forms the base substrate 10 is a wave-absorbing body, and the electromagnetic waves output by the inductor element 40 are also absorbed and attenuated, as shown in FIG. 2B.

However, the above-mentioned dielectric layer 31 allows the inductor element 40 and the base substrate 10 to be separately arranged in this embodiment.

The thickness of the dielectric layer 31 may be greater than 20 μm, for instance.

In this arrangement, it is possible to inhibit the absorption by the base substrate 10 of the electromagnetic waves output by the inductor element 40.

In other words, eddy current loss in the base substrate 10 can be reduced.

It is preferable that a material with small dielectric dissipation factor be used as the material forming the dielectric layer 31.

The dielectric dissipation factor indicates the electric energy loss level within an insulating body when alternating current is impressed on it.

By using a material with small dielectric dissipation factor as the material of the dielectric layer 31, the absorption of electromagnetic waves output by the inductor element 40 as eddy current loss can be inhibited in the base substrate, and the performance of the inductor element as an antenna can be enhanced.

More specifically, it is preferable that a material such as polyimide or benzocyclobutene (BCB) or fluoride resin be used as the material of the dielectric layer 31.

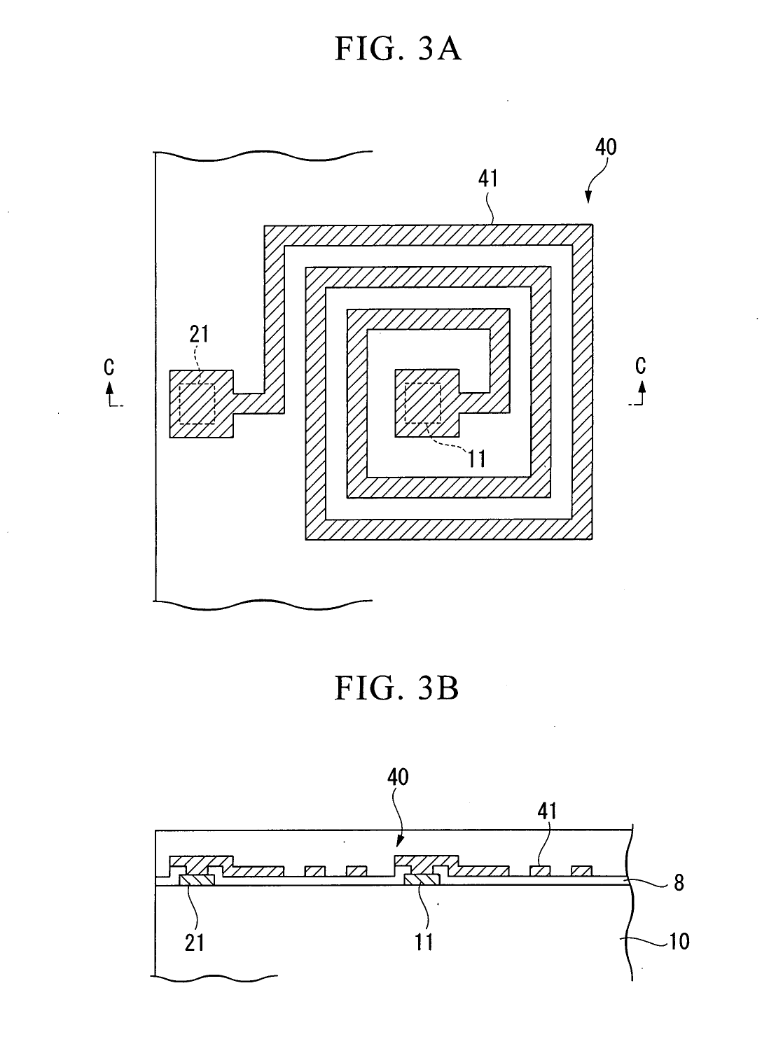

FIGS. 3A and 3B are explanatory views of the examples of modification of the inductor element. FIG. 3A shows a plan view, while FIG. 3B shows the cross-sectional view taken along the line C-C in FIG. 3A.

As shown in FIG. 3B, the above-mentioned dielectric layer is not formed in this example of modification. Thus, the winding wire 41 of the inductor element 40 is directly formed on the surface of the passivation film 8.

Moreover, since a dielectric layer is not formed, grade separation of the winding wire 41 and the connecting wire cannot be made as mentioned above.

For this reason, the inner end of the winding wire 41 connected to the electrode 11 is formed at the center of the winding wire 41, as shown in FIG. 3A.

Also, the inductor element 40 may be formed on the surface of the passivation film 8 shown in FIG. 3B, a dielectric layer formed to cover this inductor element, and other inductor elements may be formed on the surface of this dielectric layer.

By overlapping the inductor elements in this way, the electronic substrate can be miniaturized.

By adjusting each inductor element with a different inductance value or different applicable frequency, interference when each inductor element is used as an antenna can be prevented.

Although the inductor element 40 is formed on the outside of the passivation film 8 in the example of modification shown in FIG. 3B, the inductor element 40 may be formed on the inside of the passivation film 8.

In this case, the winding wire 41 may be made of a conductive material such as Cu or Al using a semiconductor element production process.

Also, inductor elements may be overlapped on the inside and outside of the passivation film 8.

Returning to FIG. 1A, the first inductor element (hereafter referred to as “active face first element”) 80 and the second inductor element (hereafter referred to as “active face second element”) 40 are formed on the active face of the base substrate 10.

The number of turns of the winding wire in active face second element 40 is more than that in the active face first element 80.

Generally, in the case in which the number of turns of the wire in the inductor element increases, the path of the inductor element becomes longer, and the inductance (L value) increases.

If the inductance increases, the applicable frequency shifts toward the low frequency side in the characteristic of the inductor.

Accordingly, the applicable frequency of the active face second element 40 shifts more toward the low frequency side than that of the active face first element 80 in the characteristic of the inductor.

The “applicable frequency” is an indication of the characteristic of the inductor as an antenna, when the inductor is made to work as an antenna, and is a frequency that can be used for an antenna.

Each inductor in the first embodiment functions as an antenna. Of these, the active face first element 80 is meant for use in communications, and the applicable frequency may be adjusted in the range of 2 to 5 GHz for high speed, large volume communications.

The active face second element 40 is used for power transmission, and the applicable frequency is adjusted in the range of several kHz to several hundred MHz.

By superimposing electromagnetic waves of high frequency for communications on low frequency electromagnetic waves for power transmission and outputting them, the active face second element can be shared for power transmission and for communications.

In each embodiment in this Specification, descriptions are given with examples of winding wire (spiral) type inductors, but this invention is not limited to these examples; any object that functions as inductor or antenna can be used in each of these embodiments.

In addition to winding wire (spiral) type inductors, meandering-type, trochoidal-type, patching-type wires are also well known. When these are used, the magnitude of the inductance value will depend on the inductor and the antenna.

As mentioned above, electrodes 11, 15, 21, and 25 are formed in an array at the peripheral portion of the active face of the base substrate 10 for electrical connectivity of the electronic circuit to external parts.

As shown in FIG. 1B, conductive member 50 penetrating through the base substrate 10 is formed below this electrode 15.

A conductive member penetrating through the base substrate 10 is also formed below the electrode 25, as shown in FIG. 1A.

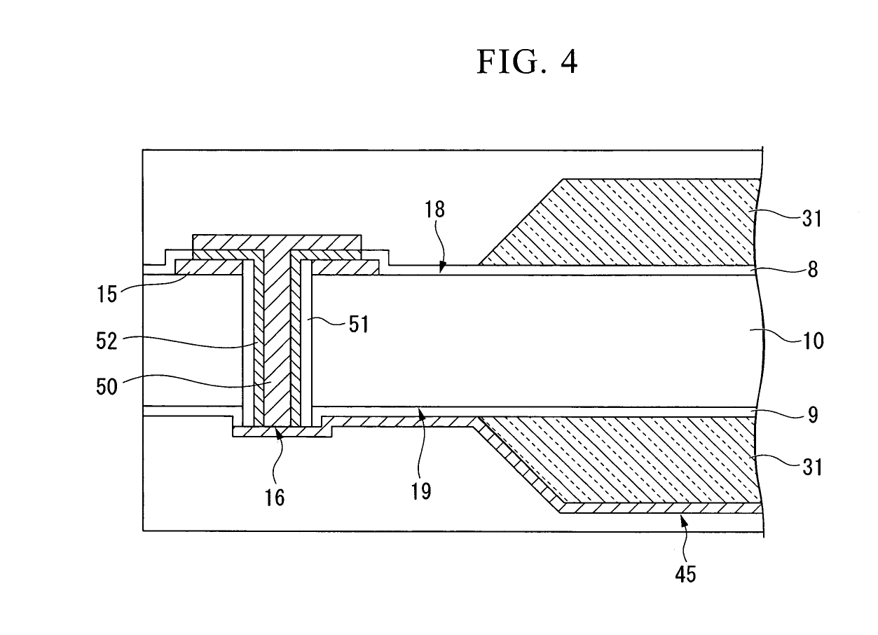

FIG. 4 is an explanatory view of a conductive member, while FIG. 1B is an enlarged view of part P in FIG. 1B.

As shown in FIG. 4, a through hole (through silicon via hole) is formed through the base substrate 10 at the center of the electrode 15 formed on the active face 18 of the base substrate 10.

Insulating layer 51 is formed on the inside face of the through hole, and base film 52 is formed extending from the inner surface of the insulating layer 51 to the surface of the electrode 15.

This base film 52 includes a lower barrier layer and an upper seed layer.

The barrier layer prevents the diffusion of Cu, a component of the conductive member 50, and is formed by compounds such as TiW or TiN.

The seed layer functions as an electrode when the conductive member 50 is formed by the electro-plating method, and it is formed by Cu or the like.

The conductive member 50 is formed extending from the surface of the electrode 15 to the inside face of the through hole.

In a forming method for the conductive member 50, a non-through hole is formed beforehand extending from the electrode 15 to the inner surface of the base substrate 10. Next, a mask with opening is formed on the surface of the electrode 15.

Next, electrolytic copper plating is performed taking the seed layer of the base film 52 as electrode, and Cu is embedded in the mask opening.

Electroless plating method or the like, may be used instead of the electro-plating method.

Subsequently, the rear face 19 of the base substrate 10 is polished, and conductive member 50 penetrating through the base substrate 10 is formed.

Insulating film 9 is formed on the rear face 19 of the base substrate 10 excluding the area formed by the conductive member 50.

An electrode 16 is formed by exposing the front end of the conductive member 50 to the rear face 19 of the base substrate 10.

Moreover, electrode 26 shown in FIG. 1C is formed by exposing the front end of the conductive member formed below the electrode 25 shown in FIG. 1A to the rear face 19 of the base substrate 10.

Moreover, the first inductor element 85 (hereafter referred to as “rear face first element”) is formed extending from electrodes 16 and 26 to the surface of the dielectric layer 31, as shown in FIG. 1C.

Similarly, the second inductor element 45 (hereafter referred to as “rear face second element”) is formed on the rear face 19 of the base substrate 10.

The number of turns of the rear face second element 45 is more than that of the rear face first element 85.

The inductance value of the rear face second element 45 is greater than that of the rear face first element 85.

The applicable frequency of the rear face second element 45 shifts more toward the low frequency side than the rear face first element 85 in the characteristic of the inductor.

The rear face second element 45 is meant for use in power transmission, similar to the active face second element. The inductance value of the rear face second element 45 or the applicable frequency of the rear face second element 45 is equivalent to that of the active face second element.

Also, the rear face first element 85 is meant for use in communications similar to the active face first element. The inductance value of the rear face first element 85 or the applicable frequency of the rear face first element 85 is different from that of the active face first element so as to prevent interference.

Semiconductor Device

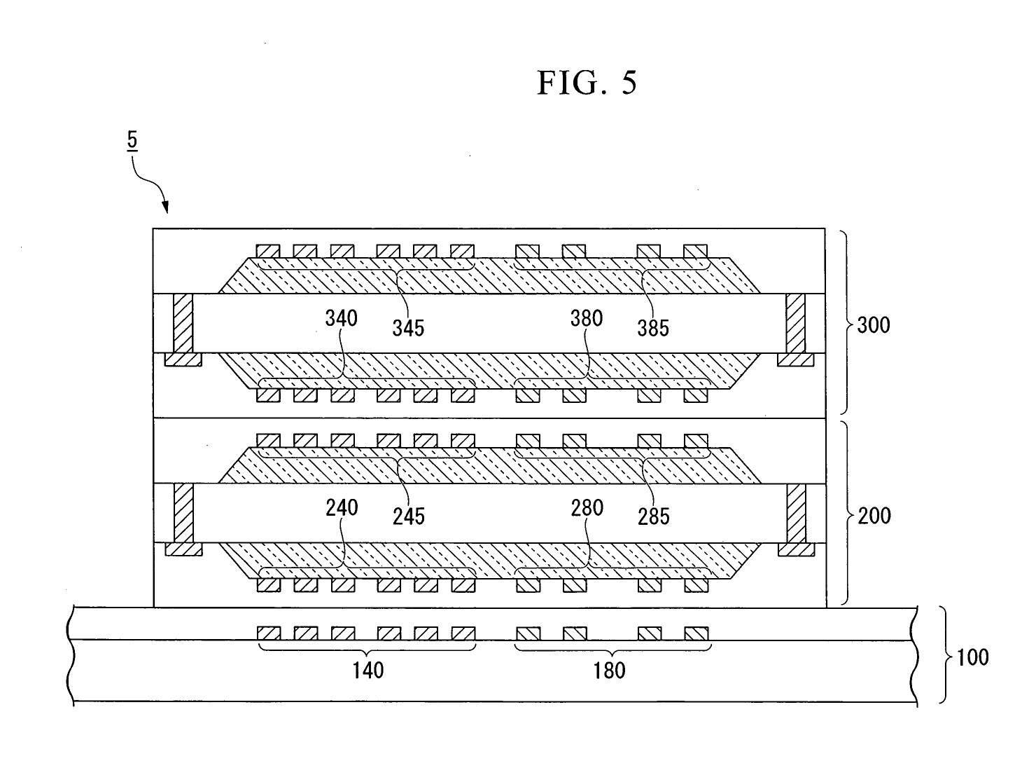

FIG. 5 is an explanatory view of a semiconductor device related to the first embodiment, and is a cross-sectional view taken along the line A-A in FIG. 1A.

As shown in FIG. 5, semiconductor device 5 related to the first embodiment, includes a motherboard 100. A first electronic substrate 200 and a second electronic substrate 300 are sequentially packaged on the surface of the motherboard 100.

The motherboard 100 is made of glass epoxy resin. A first inductor element 180 and a second inductor element 140, which function as antenna, are formed on the upper surface of this motherboard 100.

This first inductor element 180 is meant for use in communications, and its applicable frequency is adjusted in the range of 2 to 5 GHz.

The second inductor element 140 is meant for use in power transmission, and the applicable frequency is adjusted in the range of several kHz to several hundred MHz.

The first electronic substrate 200 is packaged on the surface of the motherboard 100 using an adhesive (not shown in the figures).

The active face first element 280 of the first electronic substrate 200 and the first inductor element 180 of the motherboard 100 are adjusted at the equivalent applicable frequency, and are arranged to face each other.

That is, the first elements 180 and 280 are arranged such that the normals of each element passing through their centerlines generally coincide.

Also, the active face second element 240 of the first electronic substrate 200 and the second inductor element 140 of the motherboard 100 are adjusted at the equivalent applicable frequency, and are arranged to face each other.

The applicable frequency of the rear face second element 245 formed on the first electronic substrate 200, is adjusted at a value equivalent to that of the applicable frequency of the active face second element 240.

In contrast, the applicable frequency of the rear face first element 285 formed on the first electronic substrate 200 is adjusted at a different applicable frequency than that of the active face first element 280.

The second electronic substrate 300 is packaged on the rear face of the first electronic substrate 200 using an adhesive (not shown in the views).

The active face first element 380 of the second electronic substrate 300 and the rear face first element 285 of the first electronic substrate 285 are adjusted at an equivalent applicable frequency and arranged to face each other.

The active face second element 340 of the second electronic substrate 300 and the rear face second element 245 of the first electronic substrate 200 are adjusted at an equivalent applicable frequency and arranged to face each other.

By passing current through the second inductor element 140 of the motherboard 100 in the semiconductor device 5 with the configuration mentioned above, electromagnetic waves are transmitted from the second inductor element 140.

This electromagnetic wave is received by the active face second element 240 of the first electronic substrate 200, and electric energy is extracted.

In this way, by sending/receiving electromagnetic wave taking each second element 140 and 240 as antenna, power is transmitted from the motherboard 100 to the first electronic substrate 200.

Electromagnetic wave is transmitted from the rear face second element 245 of the first electronic substrate 200, and received by the active face second element 340 of the second electronic substrate 300. Thus, power is transmitted from the first electronic substrate 200 to the second electronic substrate 300.

As the result, the first electronic substrate 200 and the second electronic substrate 300 can be driven.

In this case, the inductor elements transmitting the electromagnetic wave are arranged to face each other. Therefore, the power transmission loss can be inhibited and the transmission efficiency can be enhanced.

Also, the electromagnetic wave sent from either the first inductor element 180 of the motherboard 100, or the active face first element 280 of the first electronic substrate 200, is received by the other element and the electrical signal is extracted.

In this way, by sending/receiving electromagnetic waves taking each of the first elements 180, 280 as antenna, communications can be performed between the first electronic substrate 200 and the motherboard 100.

Moreover, the electromagnetic wave sent from either the rear face first element 285 of the first electronic substrate 200 or the active face first element 380 of the second electronic substrate 300 is received by the other element, and communications are performed between the first electronic substrate 200 and the second electronic substrate 300.

By appropriately adjusting the applicable frequency and the output of the rear face first element 385 formed on the second electronic substrate 300, communications can be performed between the semiconductor device 5 and external parts.

However, if there is no need to perform communications between the semiconductor device 5 and external parts, then the formation of the rear face first element 385 can be omitted.

Furthermore, the communication frequency between the motherboard 100 and the first electronic substrate 200 is adjusted at a value different from the communication frequency between the first electronic substrate 200 and the second electronic substrate 300.

Thus, interference between the substrates can be prevented, and the operational reliability of the semiconductor device 5 can be improved.

As described above, the configuration of electronic substrate related to this embodiment includes inductor elements formed on both the active face and the rear face of the base substrate. The inductor element formed on the rear face is electrically connected to the active face through the conductive member penetrating through the base substrate.

According to this configuration, even if a plurality of electronic substrates is disposed by stacking, the inductor elements of the adjacent electronic substrate can be arranged to face each other.

As the result, the need for sending/receiving electromagnetic wave through a base substrate with electromagnetic shielding properties does not arise, and electromagnetic waves can be sent/received at low power consumption and at a high S/N ratio.

Accordingly, the transmission efficiency can be enhanced.

As described above, the inductor elements with different inductance values or applicable frequencies are formed on the active face and rear face of the base substrate. Of these elements, the first inductor element is used for communications while the second inductor element is used for power transmission.

According to this configuration, power transmission and communications become possible using the inductor elements formed on the electronic substrate. Thus, there is no need to provide connection terminals on the electronic substrate, and hence, the construction of the electronic substrate can be simplified.

As a result, the packaging operation of electronic substrates for motherboards can be simplified.

More specifically, accurate alignment of the two components and reflow work are not necessary.

Moreover, the degradation in reliability accompanying packaging operation can be prevented.

More specifically, defective conduction and short-circuiting accompanying packaging operation can be prevented.

In this way, the occurrence of production defects can be inhibited, therefore the production yield can be improved.

### Second Embodiment

Next, the electronic substrate related to the second embodiment is described here.

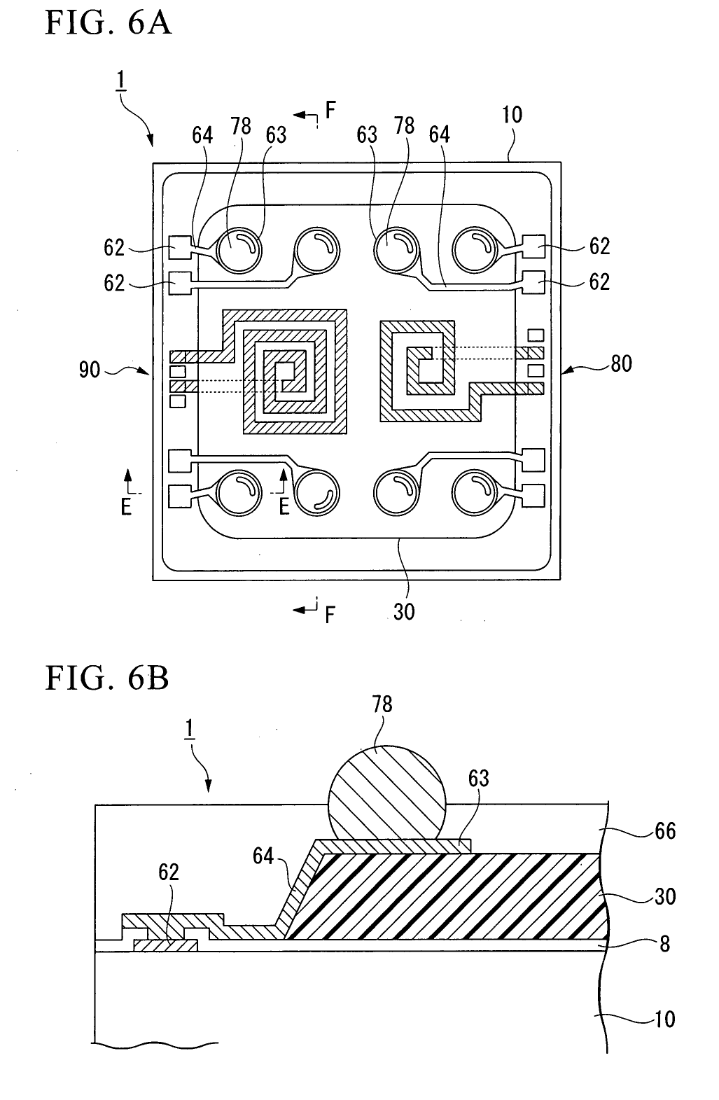

FIGS. 6A and 6B are explanatory views of the electronic substrate related to the second embodiment. FIG. 6A shows a plan view, while FIG. 6B shows the cross-sectional view taken along the line F-F in FIG. 6A.

As shown in FIG. 6A, electronic substrate 1 related to the second embodiment differs from the first embodiment that performs power transmission using inductor elements in that it performs power transmission using connection terminal 63.

Moreover, the electronic substrate related to the second embodiment differs from the first embodiment in that it performs communications using a plurality of inductor elements 80 and 90.

Note that detailed explanations of parts with the same configuration as the first embodiment are omitted here.

Relocated Wiring and So On

As shown in FIG. 6A, a plurality of electrodes 62 are aligned along the peripheral edge of electronic substrate 1 to receive external power supply.

Due to the miniaturization of electronic substrate 1 in recent years, the pitch of the adjacent electrodes 62 has become extremely small.

When this electronic substrate 1 is packaged on a member on the other side, there is concern that short-circuitting occur between the adjacent electrodes 62.

To increase the pitch of the electrodes 62, relocated wiring 64 of electrode 62 has been formed.

More specifically, connection terminal 63 including pads is formed at the center of the surface of the electronic substrate 1.

The relocated wiring 64 drawn out from electrode 62 is connected to this connection terminal 63.

As a result, the electrode 62 of small pitch is drawn out to the center and the pitch is increased.

Wafer Level Chip Scale Package (W-CSP) technology is used in the formation of such an electronic substrate 1. In this technology, batch relocated wiring and resin sealing are performed to separate each electronic substrate 1.

As shown in FIG. 6B, bump 78 is formed on the surface of the connection terminal 63.

This bump 78 may be a solder bump, and is formed by a method such as the printing method.

This bump 78 is dissolved by reflow or other method, and connected to the connection terminal of member on the other side.

Solder resist 66 is formed around the bump 78.

The solder resist 66 becomes a wall of the solder bump 78 when the electronic substrate 1 is packaged on the member on the other side, and includes a material such as resin material with electric insulating properties.

The entire surface of the electronic substrate 1 is covered by the solder resist 66.

However, when the electronic substrate 1 is packaged on a member on the other side, because of the difference in the coefficient of thermal expansion between the base substrate 10 of the electronic substrate 1 and the member on the other side, thermal stress is generated between the two members.

A stress relaxation layer 30 is formed between the connection terminal 63 and the base substrate 10 for relaxation of this thermal stress.

The stress relaxation layer 30 is formed to a specific thickness using photosensitive polyimide, benzocyclobutene (BCB), or a resin material such as phenolic novolac resin.

As shown in FIG. 6A, a plurality of inductor elements 80 and 90 is also formed on active face of the electronic substrate 1 related to the second embodiment.

Flat inductor elements (spiral inductor element) similar to the first embodiment are used as the inductor elements 80 and 90.

The winding wire of each inductor element 80 and 90 is formed on the surface of the stress relaxation layer 30 mentioned above.

This stress relaxation layer 30 includes a resin material that is dielectric. Thus, it functions similar to the dielectric layer in the first embodiment.

Accordingly, each inductor element 80 and 90 can be arranged separately from the base substrate 10 by the stress relaxation layer 30, and the electromagnetic wave output from each inductor element 80 and 90, can be inhibited from being absorbed by the base substrate 10.

The number of turns of the second inductor element 90 (hereafter referred to as “active face second element”) is greater than that of the first inductor element 80 (hereafter referred to as “active face first element”).

Accordingly, the applicable frequency of the active face second element 90 shifts more toward the low frequency side than that of the active face first element 80 in the characteristic of the inductor.

However, the active face second element 90 is not used for power transmission, but is used for communications together with the active face first element 80.

For this reason, the applicable frequency of the active face first element 80 and the active face second element 90 are both adjusted in the range of 2 to 5 GHz.

The difference in the applicable frequency of the active face second element 90 and the active face first element 80 is small compared to the difference in the first embodiment.

Manufacturing Method for Electronic Substrate

Next, the manufacturing method for the electronic substrate related to the second embodiment is described here.

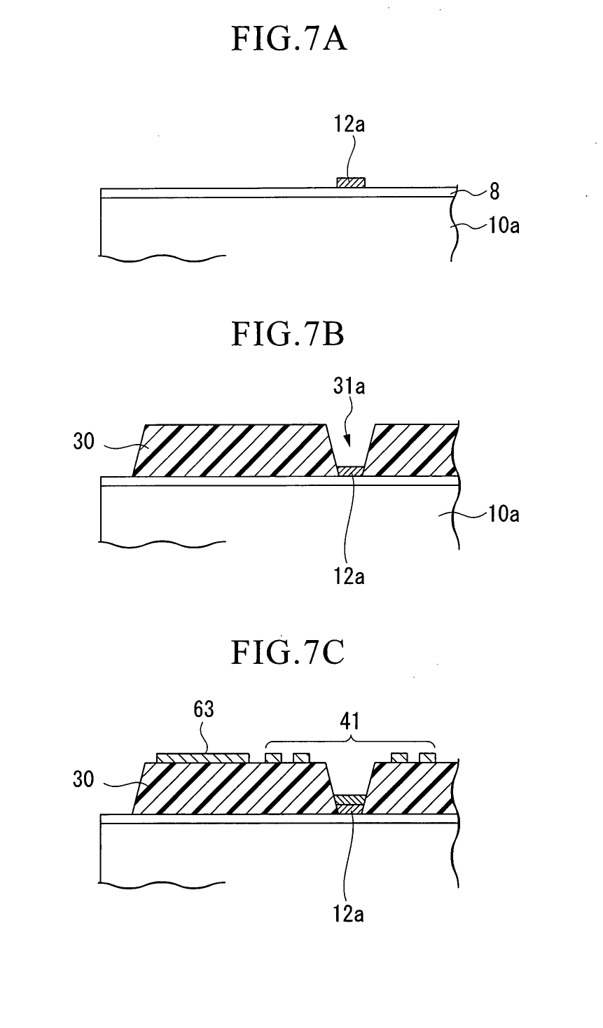

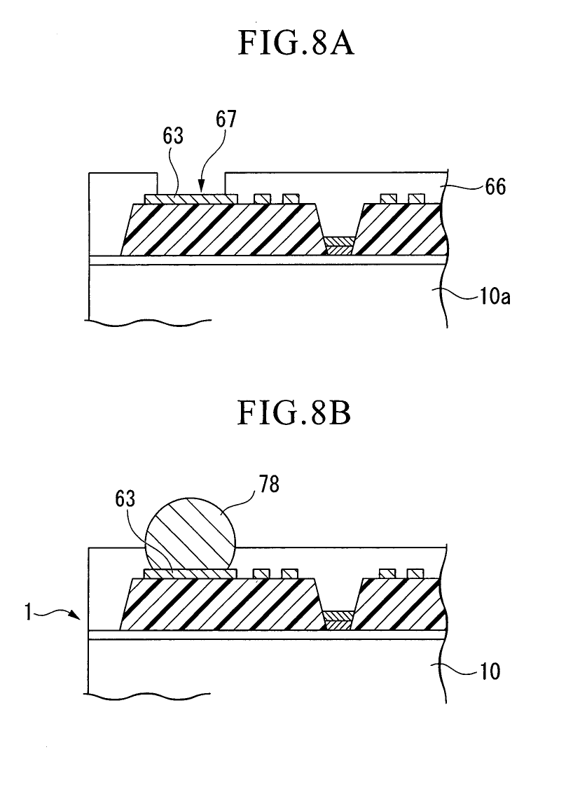

FIGS. 7A to 8B are process diagrams of the manufacturing method for electronic substrate related to the second embodiment, they show cross-sectional views taken along the line F-F in FIG. 6A.

The W-CSP technology is used in the production of electronic substrate.

That is, all the processes below for wafers are batch processed, and finally each electronic substrate is separated.

First, as shown in FIG. 7A, a connecting wire 12a is formed on the surface of the passivation film 8 of a wafer 10a.

Its pre-requisite is that a base film (not shown in the figures) be formed over the entire surface of the passivation film 8.

This base film includes a lower barrier layer and an upper seed layer.

The barrier layer prevents diffusion of Cu constituting the connecting wire 12a, and is formed to a thickness of about 100 nm by compounds such as TiW or TiN.

The seed layer functions as an electrode when the connecting wire 12a is formed by the electroplating method, and is formed continuously to a thickness of 100 nm by Cu or the like.

These layers are generally formed by methods such as the sputtering method, the CVD method and the electroless plating method.

Next, a mask with opening is formed in the formation area of the connecting wire 12a.

Next, electrolytic copper plating is performed taking the seed layer of the base film as the electrode, Cu is embedded in the mask opening, and the connecting wire 12a is formed.

This wire may also be formed by a method such as the electroless plating method.

After mask removal, the base film is etched with the connecting wire 12a as the mask.

Next, as shown in FIG. 7B, the stress relaxation layer 30 is formed on the surface of the wafer 10a.

A through hole 31a of the stress relaxation layer 30 is formed such that one end of the connecting wire 12a is exposed.

The stress relaxation layer 30 provided with the through hole 31a can be formed by using a method such as the printing method or photolithography.

Especially, if a photosensitive resin material is used as a component of the stress relaxation layer 30, the stress relaxation layer 30 can be patterned easily and accurately using photolithography.

Next, as shown in FIG. 7C, the relocated wiring and the connection terminal 63 (hereafter referred to as “connection terminal 63 or the like”) are formed on the surface of the stress relaxation layer 30.

During the formation process of the connection terminal 63 or the like, winding wire 41 is formed on the surface of the stress relaxation layer 30 simultaneously with the formation of the connection terminal 63 or the like.

More specifically, this method is similar to the method of formation of the connecting wire 12a mentioned above.

In this way, by forming the winding wire 41 simultaneously with the connection terminal 63 or the like, the production process can be simplified and the production cost can be reduced.

Also, the winding wire 41 can be accurately formed using a method such as plating or photolithography, and inductor element with the desired characteristics can be formed.

By trimming the winding wire 41 formed on the surface of the stress relaxation layer 30 by laser or other means, the characteristics of inductor element can be tuned.

Next, solder resist 66 is formed on the entire surface of the wafer 10a, as shown in FIG. 8A.

Opening 67 of the solder resist 66 is formed above the connection terminal 63.

Next, bump 78 is formed on the surface of the connection terminal 63 on the inside of this opening, as shown in FIG. 8B.

Moreover, conductive member penetrates through the base substrate 10 is formed.

The formation of the conductive member may be after the completion of each of the processes mentioned above for the active face, but if it is formed simultaneously with the formation process of the connecting wire or winding wire for the active face, the production process can be simplified.

Also, stress relaxation layer and inductor elements are formed on the rear face of the base substrate 10.

The formation of these items may be after the completion of each of the processes mentioned above for the active face, but if formed simultaneously with each of the processes mentioned above for the active face, the production process can be simplified.

Subsequently, each base substrate 10 is separated from the wafer.

The separation of the base substrate 10 can be done by a method such as dicing.

The above step completes the electronic substrate 1 related to this embodiment.

Semiconductor Device

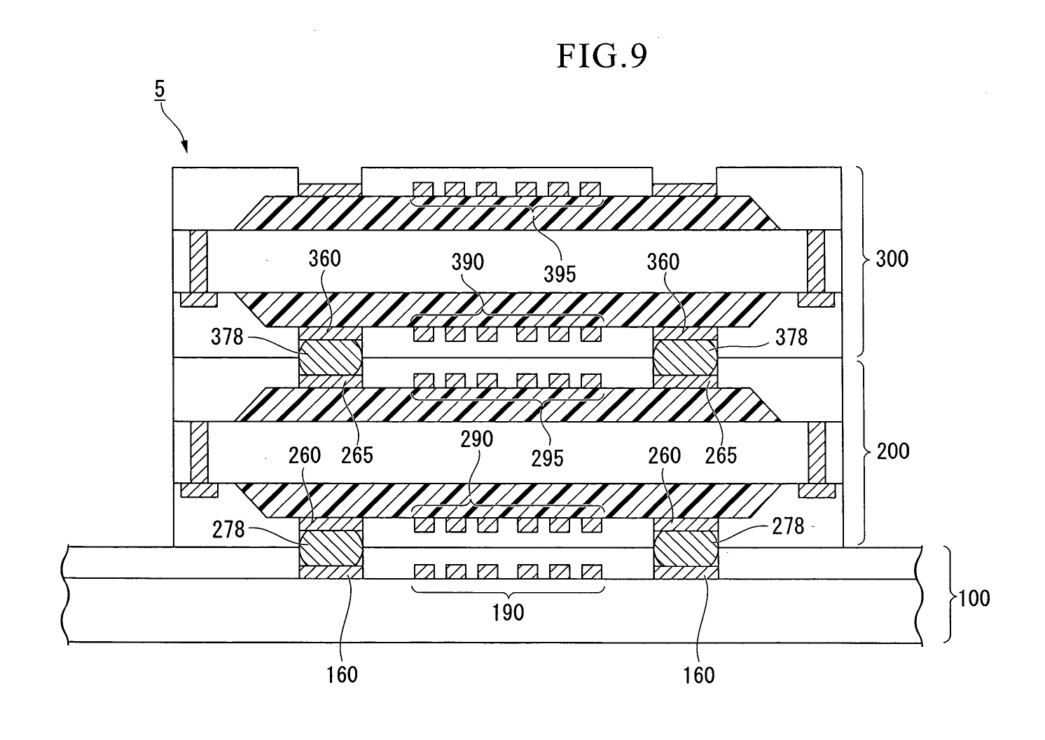

FIG. 9 is an explanatory view of the semiconductor device related to the second embodiment, and is a cross-sectional view taken along the line F-F in FIG. 6A.

As shown in FIG. 9, semiconductor device 5 related to the second embodiment, includes a motherboard 100. A first electronic substrate 200 and a second electronic substrate 300 are sequentially packaged on the surface of the motherboard 100.

The connection terminal 160 connecting the first electronic substrate 200 is formed on the surface of the motherboard 100.

Also, the first inductor element (not shown in the figures) and the second inductor element 190 are formed on the surface of the motherboard 100.

Since each inductor element is used for communications, the applicable frequency is adjusted in the range of 2 to 5 GHz.

The first electronic substrate 200 is packaged on the surface of the motherboard 100.

More specifically, the connection terminal 260 formed on the active face of the first electronic substrate 200 is disposed such that it faces the connection terminal 160 of the motherboard 100.

The solder bump 278 formed on the surface of the connection terminal 260 of the first electronic substrate 200 is connected to the connection terminal 160 of the motherboard 100 by reflow or other methods.

Also, the active face first element (not shown in FIG. 9) of the first electronic substrate 200 and the first inductor element of the motherboard 100 are formed at the equivalent applicable frequency, and are disposed to face each other.

Also, the active face second element 290 of the first electronic substrate 200 and the second inductor element 190 of the motherboard 100 are formed at the equivalent applicable frequency, and are disposed to face each other.

The applicable frequency of the rear face first element (not shown in the figures) formed on the first electronic substrate 200 is adjusted to be different from the applicable frequency of the active face first element.

The applicable frequency of the rear face second element 295 formed on the first electronic substrate 200, is adjusted at a value different from the applicable frequency of the active face second element 290.

On the other hand, the second electronic substrate 300 is packaged on the rear face of the first electronic substrate 200.

More specifically, the connection terminal 360 formed on the active face of the second electronic substrate 300 is disposed so as to face the connection terminal 265 of the first electronic substrate 200.

The solder bump 378 formed on the surface of the connection terminal 360 of the second electronic substrate 300 is connected to the connection terminal 265 of the first electronic substrate 200 by reflow or other methods.

Also, the active face first element (not shown in FIG. 9) of the second electronic substrate 300 and the rear face first element of the first electronic substrate 200 are adjusted at an equivalent applicable frequency and arranged to face each other.

Moreover, the active face second element 290 of the second electronic substrate 300 and the rear face second element 295 of the first electronic substrate 200 are adjusted at an equivalent applicable frequency and arranged to face each other.

The semiconductor device 5 configured as mentioned above, transmits power from the motherboard 100 to the first electronic substrate 200 through the connection terminals 160 and 260, and also transmits power from the first electronic substrate 200 to the second electronic substrate 300 through the connection terminals 265 and 360.

In this way, power transmission can be performed correctly and in a stable manner through connection terminals.

This also improves the operational reliability of the semiconductor device 5.

Also, the first inductor element of the motherboard 100 and the active face first element of the electronic substrate 200 in the semiconductor device 5 function as antenna and send/receive electromagnetic waves. Moreover, the second inductor element 190 of the motherboard 100 and the active face second element 290 of the first electronic substrate 200 function as antenna and send/receive electromagnetic waves. As a result, communications are performed between the motherboard 100 and the first electronic substrate 200.

In this case, since the applicable frequency of the pair of first elements and the pair of second elements is different, interference can be prevented.

For instance, the electromagnetic wave transmitted by the first inductor element of the motherboard 100 is received only by the active face first element having the same applicable frequency in the first electronic substrate 200, and not received by the active face second element 290 having a different applicable frequency.

In this way, by preventing interference, multi-bit serial communications can be performed, and communication speed can be improved.

It is needless that the motherboard 100 and the first electronic substrate 200 are aligned with high precision, so that the production cost can be reduced.

Also, the rear face first element of the first electronic substrate 200 and the active face first element of the second electronic substrate 300 in the semiconductor device 5 function as antenna and send/receive electromagnetic waves. Moreover, the rear face second element 295 of the first electronic substrate 200 and the active face second element 390 of the second electronic substrate 300 function as antenna and send/receive electromagnetic waves. As a result, communications are performed between the first electronic substrate 200 and the second electronic substrate 300.

Also, here, the applicable frequencies of the pair of first elements and pair of second elements are different. Thus, interference is prevented and multi-bit serial communications can be realized.

Furthermore, the communication frequency between the motherboard 100 and the first electronic substrate 200 is adjusted at a value different from the communication frequency between the first electronic substrate 200 and the second electronic substrate 300.

Thus, by preventing interference between the substrates, the operational reliability of the semiconductor device 5 can be improved.

Electronic Device

Next, the example of an electronic device provided with the electronic substrate mentioned above, is described here.

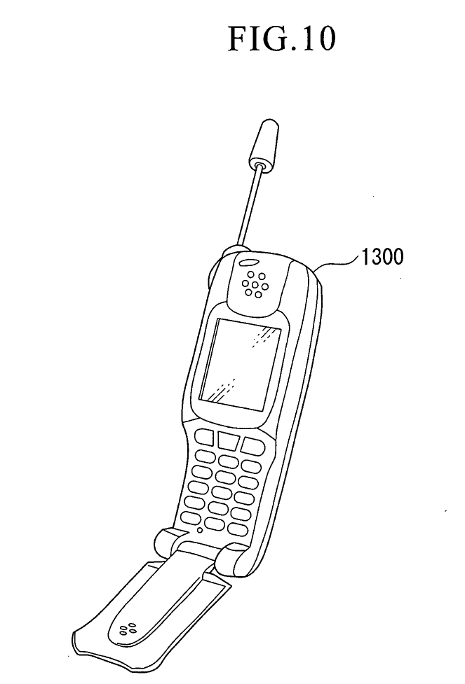

FIG. 10 is a perspective view of a mobile telephone.

The electronic substrate mentioned above is disposed within the body of a mobile telephone 1300.

According to this configuration, since the mobile telephone 1300 includes the electronic substrate in which transmission efficiency is enhanced, the mobile telephone 1300 with low power consumption can be offered.

The electronic substrate mentioned above can be used in various kinds of electronic devices in addition to the mobile telephone.

For instance, it can be used in electronic devices such as liquid crystal projector, multimedia personal computer (PC) and engineering workstation (EWS) pager, word processor, television, viewfinder-type or direct-viewing type video tape recorder, electronic organizer, desktop electronic calculator, car navigation system, POS terminal, and other devices equipped with touch panel.

In all cases, low-power consumption electronic devices can be offered.

Note that the scope of the skill of this invention is not limited to the embodiment mentioned above, and various changes may be effected to this embodiment without departing from the spirit and scope of this invention.

That is, the materials or layer configuration given in detail in the embodiment are merely examples, and these can be changed appropriately.

For instance, two inductor elements were formed on or above the active face and the rear face of the base substrate in the embodiment mentioned above, but even three or more inductor elements may be formed.

Moreover, in the embodiment mentioned above, all inductor elements were made to function as antenna, but a part of the inductor elements may be made to function as passive elements and oscillator circuits may be formed.

Also, in the embodiment above, inductor element was formed on the base substrate on which electronic circuit was formed, but inductor element may even be formed on a base substrate made of an electrically-insulated material.

In the embodiment above, winding wire was formed by electro-plating method, but other film formation methods such as sputtering method or vapor deposition method may be used.

Patterns of injector or antenna may be directly formed using a method such as an injection method without going through the film formation process.

Among all the embodiments described above, only examples of formation of inductor or antenna on electronic substrate were described. However, this invention is not limited to only these examples, and parts other than inductor formed by the thin film or thick film process, such as for instance, compound electronic parts comprising capacitors and resistors may be formed on the electronic substrate.

Moreover, these parts may be formed as compound electronic parts on electronic substrate using a different method, such as by surface packaging technology.

What is claimed is:

1. An electronic substrate comprising:
a base substrate having an active face and a rear face;
inductor elements formed on or above the active face, and formed on or above the rear face; and
a conductive member electrically connected to the inductor element formed on or above the rear face, penetrating through the base substrate from the active face to the rear face.

2. The electronic substrate according to claim 1, further comprising
a connection terminal formed on the base substrate, used for external power transmission.

3. The electronic substrate according to claim 1, further comprising
a plurality of the inductor elements formed on or above the active face, or on or above the rear face.

4. The electronic substrate according to claim 1, further comprising:
a first inductor element; and
a second inductor element having an inductance value or an applicable frequency that is different from that of the first inductor element.

5. The electronic substrate according to claim 4, wherein
the first inductor element is used for external power transmission, and
the second inductor element is used for external communications.

6. The electronic substrate according to claim 4, wherein
the first inductor element and the second inductor element are used for external communications.

7. The electronic substrate according to claim 1, further comprising:
a dielectric layer formed between at least some of the inductor elements and the base substrate, made of material having a dielectric dissipation factor smaller than that of the base substrate.

8. A semiconductor device, comprising:
a plurality of electronic substrates, each of which includes: a base substrate having an active face and a rear face; inductor elements formed on or above the active face and formed on or above the rear face; a conductive member electrically connected to the inductor elements formed on the rear face, penetrating through the base substrate from the active face to the rear face, wherein
the electronic substrates are disposed so as to be laminated, and
the inductor element functions as an antenna sending or receiving electromagnetic waves so as to send or receive signals between the electronic substrates.

9. The semiconductor device according to claim 8, wherein
the inductor elements formed on a pair of the electronic substrates, sending or receiving signals, are disposed to face each other.

10. An electronic device comprising:
the electronic substrate according to claim 1.
